(19) United States
(12) Patent Application Publication
(10) Pub. No.: US 2006/0169930 A1
(43) Pub. Date: Aug. 3, 2006

(54) Plane elements for the absorption or reduction of the reflection of electromagnetic waves

(76) Inventor: Michael Maurice Butler, Isle of Wight (GB)

Correspondence Address: CROWELL & MORING LLP;INTELLECTUAL PROPERTY GROUP, P.O. BOX 14300, WASHINGTON, DC, 20044-4300, US

(21) Appl. No.: 10/507,177

(22) PCT Filed: Jul. 28, 2004
(86) PCT No.: PCT/GB04/03272

§ 371 Date: Sep. 10, 2004

(30) Foreign Application Priority Data
Aug. 21, 2003 (GB) 0319636.7
Aug. 21, 2003 (GB) 03255172.3

(51) Int. Cl. H01J 5/18

(52) U.S. Cl. 250/505.1

(57) ABSTRACT

An apparatus for reducing the electromagnetic radiation reflected from structures in the direction of electromagnetic radiation receiving equipment is disclosed. The apparatus, situated between an object (6) and a source of electromagnetic radiation (10), comprises an array (2) of at least one substantially reflective panel (4) arranged such that the array reflects and disperses incident electromagnetic radiation away from the receiving equipment (8). The apparatus therefore provides means of reducing the adverse effects of large structures on electromagnetic radiation communications (i.e. transmission and reception).

This invention relates to electromagnetic radiation reflecting objects, particularly to the reduction of electromagnetic radiation reflected from objects in the direction of electromagnetic radiation receiving equipment.

It is well known to minimise the electromagnetic radiation reflected by objects, for example to minimise the radar cross-section (RCS) of objects, particularly military aeroplanes, by shaping the surface of the object, for example to be spherical to encourage isotropic reflection. However there are circumstances where design constraints such as structural strength, shape requirements or material properties prevent the design achieving the desired reflection characteristics. Also such characteristics are altered by small construction details and by ageing effects such as joint corrosion. The practical realisation of a structure may therefore exhibit undesirable reflection characteristics.

The reflection characteristics of problematic structures are sometimes modified by the application of absorbing materials to the surface of the structure to attenuate the reflecting signal. However such materials and surface treatments have limitations. The band of frequencies over which they are effective is limited by the properties of the materials used and the materials may degrade with time requiring repair to maintain the desired reflection characteristics. Such surface treatments are not suitable for structures that require openings, such as windows.

Surface treatments that cause cancellation of reflections by destructive interference are only effective over a limited range of frequencies and such treatments require a skin of material to be applied. Such treatment would not be possible where the surface of the structure is an essential part of the structure function, such as the blade of a wind turbine.

It is therefore an object of the invention to provide means external to a structure to overcome the disadvantages of the prior art, as hereinbefore described.

Accordingly the present invention provides apparatus for reducing the electromagnetic radiation reflected from structures in the direction of electromagnetic radiation receiving equipment. It therefore provides a means of reducing the adverse effects of large structures, for example buildings or wind turbines on electromagnetic radiation communications (i.e. transmission and reception).

Advantageously the means does not degrade with time, unlike the rubbery materials used in the prior art which tend to crumble or absorb water over time, thereby degrading performance.

In accordance with the present invention the apparatus comprises an array of at least one substantially reflective panel provided between at least one object and at least one electromagnetic radiation receiver, and arranged to reflect and disperse incident electromagnetic radiation away from each receiver.

For the purpose of this invention, the term ‘array’ is used to describe a two- or three-dimensional, regular or irregular, arrangement of the panels.

The apparatus may be attached to an outer surface of each object or may be placed distant from each object.

The substantially reflective panels may be made of materials reflective to electromagnetic radiation or may comprise a substrate having a reflective coating. Such sheets of reflective material or sheets with reflective surfaces are relatively inexpensive.

Optionally, at least one of the panels is substantially absorptive to electromagnetic radiation. The absorptive properties lead to a reduction of the electromagnetic radiation reflected from the array, thereby reducing the electromagnetic radiation reflected in the direction of the receiving equipment.

Advantageously, the panels may be generally planar or generally curved, and the size and shape of the panels may be chosen as required, for example for aesthetic purposes.

Additionally, at least one of the panels may have a multi-faceted surface such that each of such panels reflects and disperses electromagnetic radiation away from the receiving equipment.

Optionally, the reflective panels are coloured, for example by chemical treatment or the application of paint. This is advantageous for aesthetic purposes.

In accordance with another aspect of the present invention, a method or reducing the electromagnetic radiation reflected from at least one object in the direction of at least one electromagnetic radiation receiver may comprise the steps of:

i) determining the direction of each receiver from each object

ii) providing an array of at least one substantially reflective panel between each object and receiver

iii) arranging each panel to reflect and disperse incident electromagnetic radiation away from each receiver.

The invention will now be described by way of example and with reference to the accompanying drawings in which:

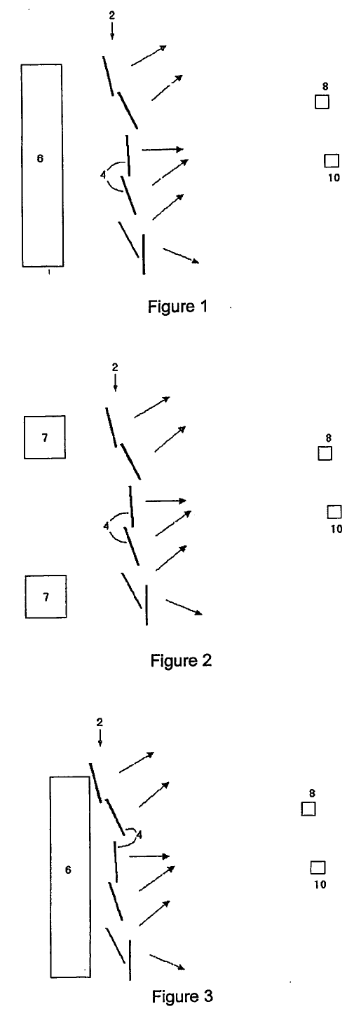

FIG. 1 is a schematic of an embodiment of the invention.

FIG. 2 illustrates a variant of the embodiment shown in FIG. 1.

FIG. 3 a schematic of an alternative embodiment of the invention.

FIG. 1 shows the apparatus according to a preferred embodiment of the invention comprising an array 2 of reflective panels 4, positioned between an object 6 and electromagnetic radiation receiving equipment 8. The panels are arranged on a support stand (not shown) at different angles to the plane of the array such that the array reflects and disperses incident electromagnetic radiation from a source 10 away from the receiving equipment 8. This therefore provides a means of reducing the adverse effects of structures, for example buildings and wind turbines, on electromagnetic radiation communications (i.e. transmission and reception). Unlike the application of absorbing materials or other treatments to the surface of the object as in the prior art, this embodiment of the present invention is suitable for objects requiring openings, for example buildings with windows and doors, or for objects where the surface of the structure is an essential part of the structure function, such as a wind turbine. It is also robust over a wide band of frequencies, not being limited by the absorptive properties of the material used.

The object masked by the array 2 may comprise more than one distinct structure 7 as shown in FIG. 2. This is advantageous when masking, for example, a collection of wind turbines, one array on a support stand being preferable to several arrays on individual support stands, particularly for cost reasons.

The array 2 may be used to mask each object from more than one electromagnetic radiation receiver. Similarly, there may be more than one source of electromagnetic radiation from which each object is masked.

Alternatively, the array 2 may be attached to an outer surface of the object 6, as illustrated in FIG. 3. In this embodiment the object 6 provides a support for the reflective panels 4, which may be attached to a backing grid (not shown), eliminating the need for a separate support stand to hold the array at the required position and therefore reducing cost.

The array 2 may comprise any number of reflective panels 4. A single panel may be used but the single unbroken reflective surface could ‘illuminate’ an adjacent object and a second reflection could possibly be intercepted by the receiving equipment. It is therefore preferable for the array to comprise multiple panels 4, with reflective surfaces at different angles to the incident electromagnetic radiation, so reflections from the individual panels are not correlated.

The panels 4 may be made of material reflective to electromagnetic radiation, for example, an aluminium alloy. This has the advantage of being lightweight and hence does not produce an undue weight burden on the structure supporting the panels. Alternatively, the panels may comprise a substrate having a reflective coating, for example, a metallised glass reinforced plastic (GRP) material. The present invention is highly advantageous over the prior art as it does not degrade with time, unlike the rubbery materials used in the prior art which tend to crumble or absorb water over time, thereby degrading performance.

At least one of the panels may be substantially absorptive to electromagnetic radiation. The absorption of some of the incident electromagnetic radiation reduces the electromagnetic radiation reflected by the array, thereby reducing the electromagnetic radiation reflected in the direction of the receiving equipment.

Naturally the material used for the panels are chosen to be compatible with the range of frequencies emitted by each source of electromagnetic radiation.

Different reflection characteristics can be provided for by altering the design of the panels 4. The reflective surface of each panel may be flat or curved (not shown).

The panels may be a variety of sizes and shapes, either regular or irregular, for example for aesthetic purposes. At least one of the panels may have a substantially reflective multi-faceted surface such that each of such panels reflects and disperses electromagnetic radiation away from the receiving equipment. The panels may be coloured either by chemical treatment or the application of a paint that does not interfere with the reflective properties of the panels.

Each array is a two- or three-dimensional arrangement of panels. Alternatively, more than one array may be positioned between the object 6 and the electromagnetic radiation receiving means 8. With this embodiment, an object may be masked from more than one range of radiation frequencies simultaneously.

The method used to reduce the electromagnetic radiation reflected from at least one object in the direction of electromagnetic receiving equipment comprises the steps of determining the direction of each electromagnetic radiation receiver from each object, providing an array of at least one substantially reflective panel between each object and each receiver, and arranging each panel to reflect and disperse incident electromagnetic radiation away from the receiving equipment.

It can therefore be envisaged that an array 2 of panels is supplied, the array positioned between each object and receiver, and the panels adjusted as required to reflect and disperse the incident electromagnetic radiation away from each receiver. Alternatively, the panels are mounted in the array directly in the position required.

Naturally if each receiver or source of electromagnetic radiation changes location, the array 2 may be repositioned or the panels 4 may be adjusted individually (adjustment means not shown in the figures).

1.-10. (canceled)

11. Apparatus for reducing electromagnetic radiation reflected from at least one object in the direction of at least one electromagnetic radiation receiver, the apparatus comprising an array, provided between each object and receiver, of at least one substantially reflective panel, each panel arranged such that the array reflects and disperses incident electromagnetic radiation away from each receiver.

12. Apparatus according to claim 11 wherein the array of panels is attached to an outer surface of each object.

13. Apparatus according to claim 12 wherein the panels are made of material substantially reflective to electromagnetic radiation.

14. Apparatus according to claim 13 wherein at least one of the panels is substantially absorptive to electromagnetic radiation.

15. Apparatus according to claim 14 wherein the panels are generally planar.

16. Apparatus according to claim 14 wherein the panels are generally curved.

17. Apparatus according to claim 15 wherein the panels are irregular in shape.

18. Apparatus according to claim 16 wherein at least one of the panels has a substantially reflective multi-faceted surface.

19. Apparatus according to claim 17 wherein at least one of the panels has a substantially reflective multi-faceted surface.

20. Apparatus according to claim 11 wherein the panels are made of material substantially reflective to electromagnetic radiation.

21. Apparatus according to claim 20 wherein at least one of the panels is substantially absorptive to electromagnetic radiation.

22. Apparatus according to claim 21 wherein the panels are generally planar.

23. Apparatus according to claim 21 wherein the panels are generally curved.

24. Apparatus according to claim 22 wherein the panels are irregular in shape.

25. Apparatus according to claim 24 wherein at least one of the panels has a substantially reflective multi-faceted surface.

26. Apparatus according to claim 11 wherein the panels comprise a substrate having a substantially reflective coating.

27. Apparatus according to claim 26 wherein at least one of the panels is substantially absorptive to electromagnetic radiation.

28. Apparatus according to claim 27 wherein the panels are generally planar.

29. Apparatus according to claim 27 wherein the panels are generally curved.

30. Apparatus according to claim 28 wherein the panels are irregular in shape.

31. Apparatus according to claim 12 wherein the panels comprise a substrate having a substantially reflective coating.

32. Apparatus according to claim 31 wherein at least one of the panels is substantially absorptive to electromagnetic radiation.

33. Apparatus according to claim 32 wherein the panels are generally planar.

34. Apparatus according to claim 32 wherein the panels are generally curved.

35. Apparatus according to claim 33 wherein the panels are irregular in shape.

36. A method for reducing electromagnetic radiation reflected from at least one object in the direction of at least one electromagnetic radiation receiver comprising the steps of:
i) determining a direction of each electromagnetic radiation receiver from each object;
(ii) providing an array of at least one substantially reflective panel between each object and receiver;
(iii) arranging each panel to reflect and disperse incident electromagnetic radiation away from each receiver.
